(19) United States
(12) Patent Application Publication
(10) Pub. No.: US 2016/0158997 A1
(43) Pub. Date: Jun. 9, 2016

(54) Deflecting Device for a Chain Composed of Tenter Clips Having Running Rollers for Transporting a Moving Material Web

(71) Applicant: LINDAUER DORNIER GESELLSCHAFT MIT BESCHRÄNKTER HAFTUNG, Lindau (DE)

(72) Inventors: Karsten RESCH, Weissensberg (DE); Kai URBANZYK, Lindau (DE); Martin VEIL, Lindau (DE)

(21) Appl. No.: 14/907,120

(22) PCT Filed: Jul. 31, 2014
(86) PCT No.: PCT/EP2014/066508

§ 371 Date: Jan. 22, 2016

(30) Foreign Application Priority Data
Aug. 14, 2013 (DE) 10 2013 216 180.8

(51) Int. Cl. B29C 55/20; B29C 55/16

(52) U.S. Cl. CPC B29C 55/20; B29C 55/165

(57) ABSTRACT

Deflecting device (3) for a chain of tenter clips (1) with running rollers (2) for the transport of a moving material web, with a sprocket (4) as well as with a guide rail (5) with at least two tracks (6.1, 6.2) for the running rollers (2) of the tenter clips (1). The two tracks (6.1, 6.2) are respectively arranged on two mutually oppositely facing sides of the guide rail (5) parallel to the rotation axis of the sprocket (4). The guide rail (5) comprises at least one curved section (5.2) for deflecting the chain. In the area of the curved section (5.2) of the guide rail (5), connecting elements (8, 9, 10) are present, by which the guide rail (5) is connected with the deflecting device (3). Several connecting elements (8, 9, 10) are embodied in such a manner so that at least a part of the curved section (5.2) of the guide rail (5) is radially slidable with respect to the sprocket (4).

### TECHNICAL FIELD

The present invention relates to a deflecting device for a chain of tenter clips with running rollers for the transport of a moving material web.

### PRIOR ART

In plants or machines for the tensioning or stretching of material webs, a plurality of tenter clips is assembled to form endlessly circulating tenter clip chains that are arranged in a longitudinal direction on both sides of a material web. The material web is transported through the tensioning or stretching machine by means of the tenter clips.

Such a machine is described, for example, in the DE 34 43 905 C2. Such machines are utilized in the production of plastic films, but also in other fields, for example for tensioning textile webs. Generally, the tenter clip includes a mechanism for tightly clamping the material web, elements for connecting the individual tenter clips to form a chain, as well as running rollers for the vertical and horizontal guidance of the tenter clips on a guide rail. Typically, the running rollers of the tenter clips and the guide rail are embodied or configured so that a support or bracing of the tenter clips in the plane of the material web is achieved on two tracks that are arranged on two mutually oppositely facing sides of the guide rails.

At the outlet of the machine, the tenter clips release the material web. There, an area is provided, in which the endless tenter clip chain is driven, deflected and brought back to the starting point via a further guidance system. The deflection of the tenter clip chains at the outlet of the machine over a chain wheel or sprocket causes interferences in the running of the tenter clips, especially in rapidly running machines with large track forces. These problems arise, for example, in the transition from straight sections of the guide rails into the area of deflections (e.g. DE 13 03 870 C2) or through chain pitch errors or defects in the tenter clip chain due to wear (for example in the DE 34 43 905 C2).

Interferences in the running of the tenter clips can also arise due to component tolerances. In order to compensate such tolerances between guide rail and running rollers in straight-extending track sections, it is proposed in the EP 0 760 740 B1 to adapt the spacing distance between the two tracks by elastic intermediate elements in the guide rail.

An object of the present invention is the provision of a deflecting device for a chain of tenter clips, in which fewer interferences arise in the area of the deflection, wherein such interferences are caused by tolerances or wear-induced chain pitch errors.

### DESCRIPTION OF THE INVENTION

The object is achieved by a deflection device for a chain of tenter clips with running rollers for the transport of a moving material web according to the independent claim.

The deflection device serves for the deflection of a chain, which is generally known, of tenter clips with running rollers, which roll along on a guide rail. Typically, the tenter clips comprise elements by which the individual tenter clips are connected with one another to form a tenter clip chain. The deflection device comprises a chain wheel or sprocket, which is arranged so that it engages into chain links or chain pins of the tenter clip chain. The sprocket can be drivable by a motor drive. Furthermore, a guide rail with at least two tracks for the running rollers of the tenter clips is provided on the deflecting device. The two tracks are respectively arranged on two mutually oppositely facing sides of the guide rail. These two tracks extend parallel to the rotation axis of the sprocket. The tracks serve to take up forces on the tenter clip, which are effective in respective directions opposed to one another parallel to the plane of the moving material web. Through this embodiment, which is generally known as such, e.g. in a stretching machine the tension forces of the material web are securely and reliably taken up by those of the running rollers that are supported or braced against the one of the two tracks, while in areas with reduced tension force or with dynamic forces, which are effective in opposed directions, a support or bracing of the forces is achieved via the running rollers that roll along the other one of the two tracks. Of course, further running rollers and tracks can be provided, over which the abovementioned forces are distributed, or which take up further forces, for example such forces that are effective perpendicularly to the plane of the moving material web.

For deflecting the tenter clip chain, the guide rail comprises at least one bent or curved section. Depending on the embodiment of the stretching machine, that can, for example, be a deflection by less than 90 degrees, by 90 degrees, by 180 degrees or by more than 180 degrees. Through one or more such deflections, the endless tenter clip chain is deflected, for example, at the end of a stretching machine from a direction in the running direction of the material web into a direction contrary to the running direction of the material web.

The deflection device according to the invention is characterized in that at least a part of the bent or curved section of the guide rail is radially slidable with respect to the sprocket.

For this purpose, connecting elements are provided, through which the guide rail is connected with the deflecting device. Several of these connecting elements are embodied or configured in such a manner so that a radial slidability of the guide rail or also only a section of the guide rail is ensured.

Through the radial slidability of the guide rail in the area of the sprocket, larger or smaller radii of curvature of the guide rail can be achieved, within certain limits, in the curved area of the guide rail. In that regard, the construction of the connecting elements is embodied so that the radial sliding displacement can take place section-wise or over the entire circumference of the curved section, and even also in the running operation of the machine. Thereby, an independent or automatic adaptation to a changed pitch (for example due to wear) of the tenter clip chain can be achieved. This can even be of different sizes in various different sections of the tenter clip chain, for example due to tolerances in the chain links.

In order to support the radial slidability of the guide rail in the area of the sprocket, it is especially advantageous if, in addition to the radial slidability, furthermore a tangential slidability of the guide rail is ensured in the area of the curved section of the guide rail. That means that the guide rail, in its curved section, is slidable also in the circumferential direction, thus tangentially with respect to the sprocket, within certain limits, in a section-wise manner or over the entire circumference of the curved section. This is especially suitable in such a case when the deflection takes place over a larger deflection angle or when the guide rail is only slightly elastic and the connecting elements for the radial slidability are arranged in close spacing distances.

In order to ensure such a tangential slidability, for example, several connecting elements can be embodied or configured in such a manner between the guide rail and the deflecting device, so that a tangential slidability of the guide rail with respect to the sprocket is possible. These can be the same connecting elements with which also the radial slidability is made possible, or also other connecting elements can be correspondingly adapted for the tangential slidability.

In order to achieve such a slidability, the fact can also be taken advantage of, that the guide rail itself comprises a certain elasticity. If degrees of freedom (that is to say play) in the radial or tangential direction are provided on the connecting elements between the guide rail and the deflecting device, then the guide rail will be held in a prescribed defined position by its own self-elasticity, which position can however be changed under the influence of larger forces. If the self-elasticity of the guide rail for this purpose cannot be suitably selected, it is also conceivable to provide spring-elastic spacer members on the connecting elements, which fix the basic position of the guide rail and which elastically yield under the effect of larger forces and thus permit a radial and/or tangential sliding displacement of the guide rail.

In a further embodiment it is provided that a straight section of the guide rail adjoins the curved section of the guide rail, and that the straight section is slidably connected with the deflecting device in the longitudinal direction of the guide rail. Through this arrangement it becomes possible to rigidly connect one end of the curved section of the guide rail with the deflecting device, while the other end can adapt itself to the radial and/or tangential sliding displacement of the guide rail in the curved section.

The guide rail can be embodied in a known type and manner, for example, as a rectangular spring steel band or as a packet of several spring bands.

The connection between the guide rail and the deflecting device typically is achieved via a rail carrier. It is advantageous if the rail carrier comprises a curved section that extends parallel to the curved section of the guide rail. Through this embodiment, the rail carrier can be arranged parallel to the guide rail and, for example, between two toothed rings or wheels of the sprocket that lie one above the other. Because chain rollers or chain pins are typically additionally also present on the tenter clip, wherein these chain rollers or chain pins are engaged with the sprocket teeth during the deflection around the sprocket, therefore the above described embodiment of the rail carrier achieves a compact structure of the tenter clip and a stable support of the guide rail. Moreover, the rail carrier can be embodied as a rectangular or T-shaped profile or sectional member.

The connecting elements can, for example, be embodied as shaft stubs, pins or studs with a longitudinal direction, wherein in that regard the longitudinal direction of the studs extends essentially in the direction of the radius of the sprocket.

In that regard, for example, bored holes for receiving the studs are present in the rail carrier. However, other manners of securing the studs on the rail carrier are also conceivable, for example a butt weld, or a combination of various different types of securing or fastening.

The guide rail can be connected with the studs in such a manner so that it is slidable with respect to the studs. That can be a slidability in the longitudinal direction of the pins, but also just as well a slidability transversely to the longitudinal direction of the studs, thus in the circumferential direction, tangentially to the curved section of the guide rail.

However, an advantageous embodiment arises in that the studs are supported to be slidable in their longitudinal direction. In this case, the length of the studs and therewith the length of the sliding guidance can be selected relatively large, so that a precise guidance of the guide rail connected with the studs is ensured in the radial direction.

Especially when also still a tangential slidability of the guide rail with respect to the sprocket is to be realized, it is advantageous if clamping elements are provided on several studs, by which clamping elements the guide rail is connected with the studs.

These clamping elements can, for example, be embodied as two-part clamping jaws, of which the one partial clamping jaw is mounted rigidly on the respective stud, while the other partial clamping jaw is secured on the first clamping jaw in such a manner so that the guide rail is held between the two partial clamping jaws so that the guide rail is slidable in its longitudinal direction, thus tangentially to the sprocket.

Radial slidability and tangential slidability can, of course, also be achieved in that the studs and the clamping elements are embodied or configured in such a manner to enable a slidability, with respect to the studs, of the clamping elements with the guide rail clamped therein.

For a secure or reliable functioning of the deflecting device according to the invention, it is further suitable if the size or magnitude of the slidability is limited. This can be made possible, for example, by contact stops in the area of the sliding paths of the connecting elements or of the guide rails.

### BRIEF DESCRIPTION OF THE DRAWING, ADVANTAGEOUS EMBODIMENTS OF THE INVENTION

FIG. 1 Section A-A, view of an embodiment of the deflecting device according to the invention

FIG. 2 Section B-B of the embodiment of FIG. 1

FIG. 3 Sectional illustration of a further embodiment in a view that approximately corresponds to the cut-out portion C in FIG. 1

FIG. 4 View D-D from FIG. 1.

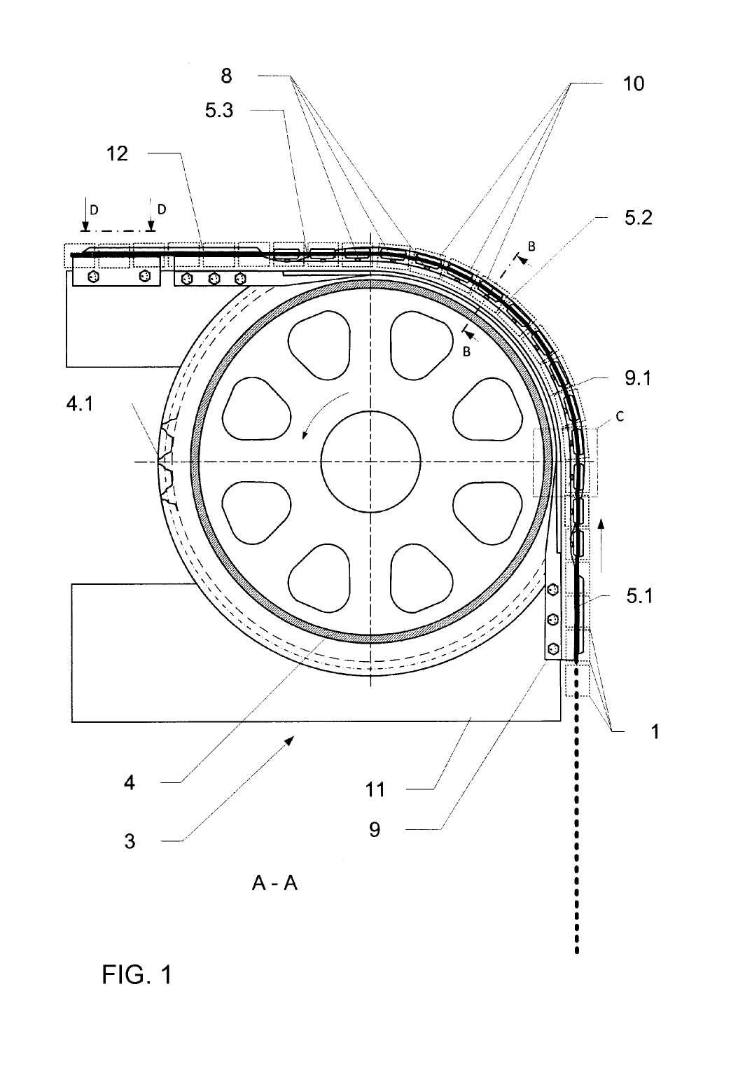

FIG. 1 shows an example of the deflecting device 3 with the chain wheel or sprocket 4 and with the guide rail 5. The guide rail 5 comprises straight sections 5.1, 5.3 and a curved section 5.2. The chain of tenter clips 1 is illustrated as a row of rectangles with a dotted outline. Beginning from the first straight section 5.1 of the guide rail 5, the tenter clip chain is deflected over the curved section 5.2 of the guide rail 5 around the sprocket 4 onto the second straight section 5.3 of the guide rail 5. In that regard, the tenter clips 1 move in the arrow direction, while the sprocket 4 rotates. In the present example, a deflection of 90 degrees occurs. A further unillustrated deflecting device deflects the tenter clip chain, for example, about a further 90 degrees, so that the tenter clip chain finally can be guided back to its starting point again.

Normally no sprocket 4 is necessary on the second unillustrated deflecting device, but rather only a further guide rail with straight and curved sections is provided. The sprocket 4 comprises two toothed portions lying one above another. In FIG. 1, merely three individual teeth 4.1 of the bottom toothed ring or wheel on the sprocket 4 are illustrated.

The guide rail 5 of the deflecting device illustrated in FIG. 1 is connected with the rail carrier 9 by several clamping elements 10 and studs 8. The rail carrier 9 comprises a curved section 9.1, which extends parallel to the curved section 5.2 of the guide rail 5. That is to say that the rail carrier 9 is curved around the sprocket 4. The rail carrier 9 is secured or fastened on the machine frame 11 of the deflecting device 3.

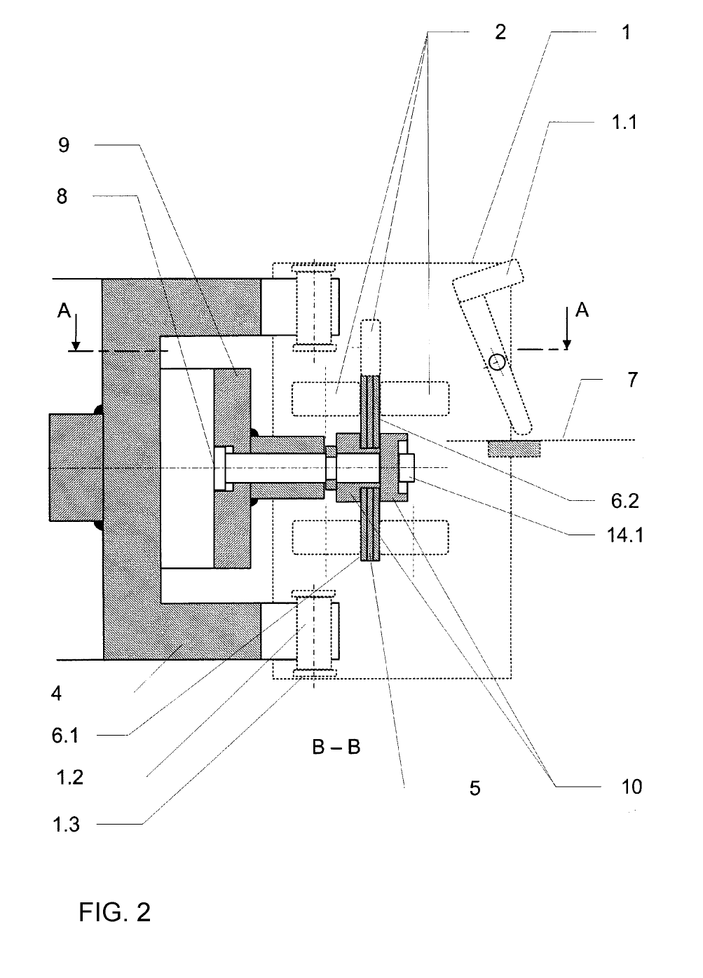

FIG. 2 shows a view in the section B-B from FIG. 1. Moreover, in FIG. 2 the section line A-A is marked, which indicates where the section line of the view A-A in FIG. 1 extends.

FIG. 2 shows some elements of the tenter clip 1 as dotted contours. Such tenter clips 1 are known from the prior art. In order to enable the understanding of the invention, these elements are, however, once again described here. The tenter clip 1 generally includes a clamping or flap mechanism 1.1 for tightly clamping the material web. The plane in which the material web extends with respect to the tenter clip is referenced with 7. In the area of the deflecting device 3, the flaps 1.1 are opened, because the material web is not also deflected, but rather extends linearly.

Furthermore, elements for connecting the individual tenter clips 1 to form a chain are present on the tenter clip 1. These are presently illustrated as two rows of chain pins 1.2 lying one above another, which are connected by the link plates 1.3 with the chain pins 1.2 of the adjacent tenter clips 1. The chain pins 1.2 engage into the two toothed rings or wheels of the sprocket 4 lying one above another. The tenter clip 1 further includes running rollers 2 for the vertical and horizontal guidance of the tenter clips 1 on the guide rail 5. In the scope of the present invention, the running rollers 2 of the tenter clips 1 and the guide rail 5 are embodied or configured so that a support of the tenter clips 1 in the horizontal direction takes place on tracks 6.1, 6.2 that are arranged on mutually oppositely facing sides of the guide rail 5. In the present example, the guide rail 5 is embodied as a packet of several spring bands. The one of the two tracks 6.1 lies on the side of the guide rail 5 facing away from the flap mechanism 1.1. That is the side of the guide rail 5 that faces toward the sprocket 4 in the area of the deflecting device 3. The track 6.1 facing toward the sprocket 4 takes up the tension forces of the material web in the plane 7 via the associated running rollers 2. The other track 6.2 lies on the side of the guide rail 5 or the spring packet facing away from the sprocket 4. Via this track 6.2 and the associated running rollers 2, dynamic acceleration forces are supported or braced, which act on the tenter clip 1 in a direction oriented opposite the tension forces of the material web. In the present example, respectively two tracks 6 are arranged one above another on each of the two track sides 6.1, 6.2 of the guide rail 5, so that the described forces can be supported or braced respectively via a pair of running rollers 2.

In the present example, connecting elements 8, 9, 10 are arranged between the two running rollers 2 lying one above the other, by which connecting elements the guide rail 5 is connected with the remaining deflecting device 3. In the example embodiment according to the FIGS. 1 and 2, the connection is achieved by a T-shaped rail carrier 9. The rail carrier 9 is provided with bored holes, in which several studs 8 are supported to be slidable in their longitudinal direction, radially to the sprocket 4. The one end of the studs 8 is provided with a stepped shoulder that serves as a contact stop for limiting the sliding displacement radially outwardly from the rotation point of the sprocket 4. Respectively two clamping jaws as clamping elements 10 are secured on the other end of the studs 8, wherein the clamping elements leave a space free between them, in which the guide rail 5 is held in a determined radial position. The two clamping jaws 10 are tensioned with one another via screws 14.1. The interspace between the two clamping jaws 10 is respectively dimensioned so that the guide rail 5 is fixed in the longitudinal direction of the stud 8 relative to the clamping jaws 10, while in the transverse direction a sliding displacement of the guide rail 5 relative to the associated stud 8 is possible. For this, in the area of the clamping jaws 10, the guide rail 5 respectively comprises an elongated or slotted hole, which enables a sliding displacement of the guide rail 5 tangentially to the sprocket 4. Moreover, the studs 8 comprise a further contact stop that serves to limit the sliding displacement of the studs 8 radially inwardly. FIG. 2 shows a starting position of the studs 8 or of the guide rail 5, in which there is not yet any change of the pitch of the tenter clip chain. Upon gradual progressive enlargement of the pitch of the chain, that is to say upon gradual progressive enlargement of the spacing distance from tenter clip 1 to tenter clip 1 in the longitudinal direction of the guide rail 5 under tension on the link plates 1.3, this would give rise to ever increasing engagement interferences between the sprocket 4 and the chain pins 1.2 of the tenter clips 1, without adaptation of the radial position of the guide rail 5. Through the inventive possibility of the radial sliding displacement of the guide rail 5 toward the outside, the pitch circle along which the chain pins 1.2 run on the sprocket 4 is enlarged. In that regard, the pitch circle is enlarged so long until the changed chain pitch kinematically fits or matches to the changed pitch circle. In this manner, the described engagement interferences in the tooth engagement between the sprocket 4 and the tenter chain are avoided.

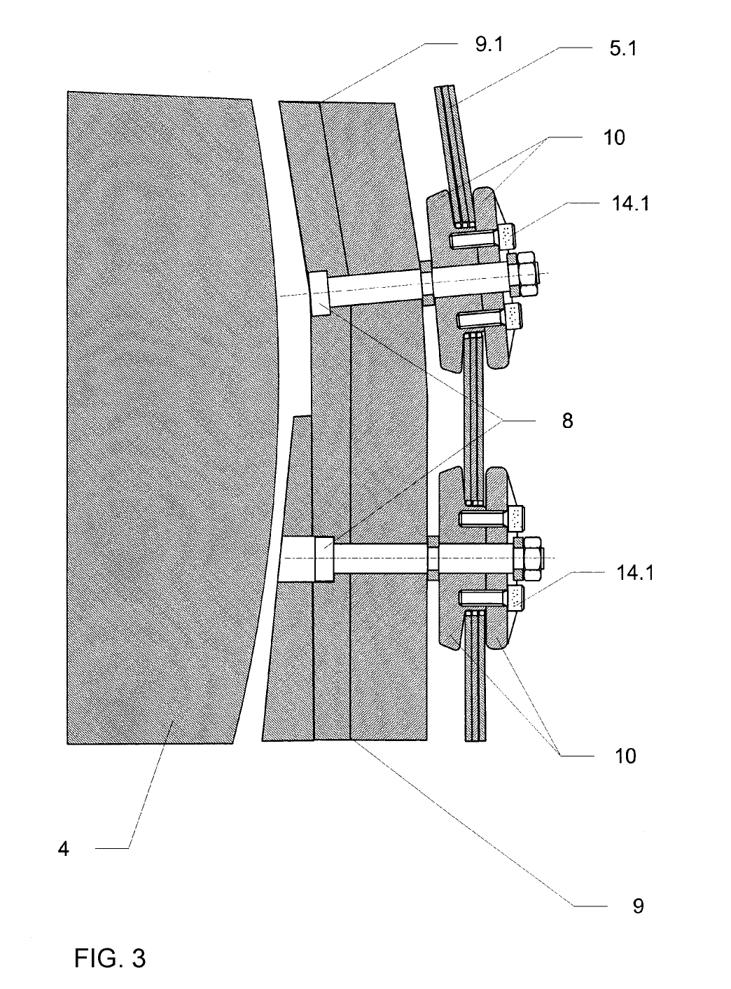

FIG. 3 shows a further embodiment of the deflecting device according to the invention. FIG. 3 shows a cut-out portion that approximately corresponds to the cut-out portion C marked in FIG. 1. However, in FIG. 3 the section line extends offset parallel to the section line A-A of the FIG. 1, and particularly in a plane through the longitudinal axis of the studs 8.

In FIG. 3 one recognizes that the studs in this embodiment are not slidable in their longitudinal direction relative to the rail carrier 9. Instead, here the clamping jaws 10 are slidable on the respective associated stud 8 in the longitudinal direction of the stud 8, thus radially to the sprocket 4. The two contact stop rings mounted or arranged on the stud serve as mutually complementary contact stops for the magnitude of the sliding displacement. Also in this example embodiment, a sliding displacement of the guide rail 5 transversely to the longitudinal direction of the studs 8 is possible, and particularly because also here the interspace between the two clamping jaws 10 relative to the thickness of the guide rail 5 is dimensioned so that merely a guidance but not a rigid clamping of the guide rail 5 is achieved. Similarly as in the previously described example, the guide rail 5 comprises corresponding elongated or slotted holes on each pair of clamping jaws 10.

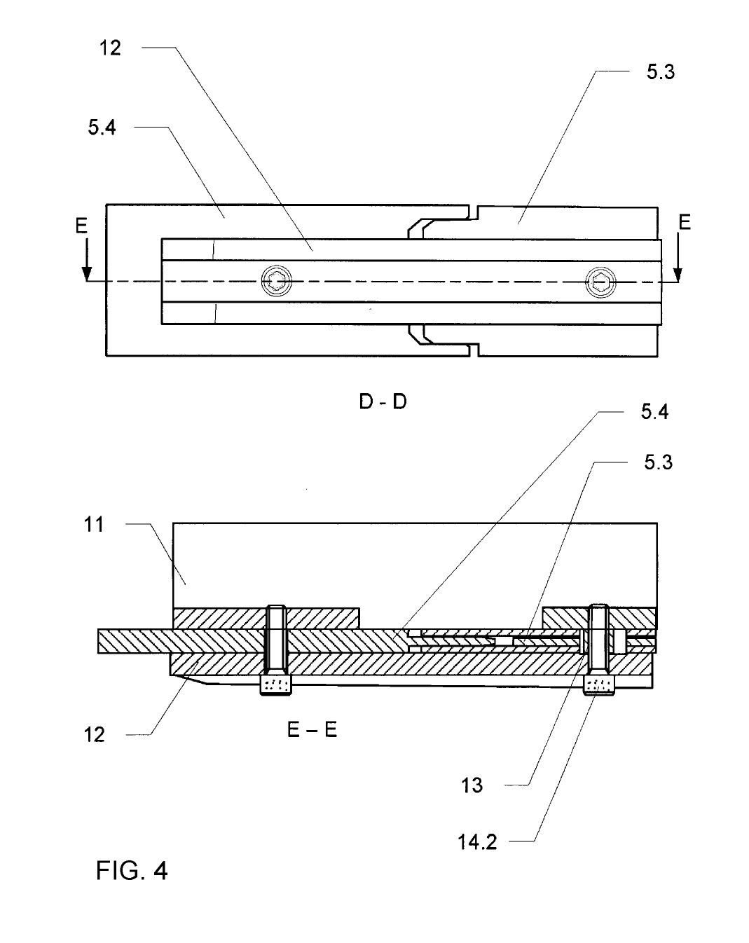

FIG. 4 shows a partial view D-D of the embodiment according to FIG. 1. At this location, the straight section 5.3 of the guide rail 5 transitions into a straight section 5.4 of a guide rail in the adjoining area of the machine. At the transition, the straight section 5.3 of the guide rail 5 is connected with the deflecting device 3 via the connecting elements 12, 13, 14.2 and via the machine frame 11 in such a manner so that a slidability in the lengthwise direction of the guide rail 5 is given. In order that this is possible, the length of the spacer sleeve 13, as well as the spacing distance between the connecting rail 12 and the fastening or connecting element of the machine frame 11 is dimensioned so that, with a tightened screw 14.2, a sliding displacement of the guide rail 5 in the longitudinal direction is still possible. In that regard, the transition to the neighboring or adjacent guide rail 5.4 is embodied through a corresponding complementary profiling of the two guide rail sections 5.3, 5.4 so that the running rollers 2 of the tenter clip 1 can run along above and below the connecting rail 12 also at the transition from the section 5.3 to the section 5.4, without becoming caught or stuck on steps or offset shoulders.

### REFERENCE NUMBERS

1, 1.1, 1.2 tenter clip
2 running rollers
3 deflecting device
4 sprocket
5.1, 5.2, guide rail
5.3, 5.4
6.1, 6.2 track
7 plane of the moving material web
8 stud
9, 9.1 rail carrier
10 clamping elements
11 machine frame
12 connecting rail
13 spacer sleeve
14.1, 14.2 clamping screw

1. Deflecting device (3) for a chain of tenter clips (1) with running rollers (2) for the transport of a moving material web, with a sprocket (4) as well as with a guide rail (5) with at least two tracks (6.1, 6.2) for the running rollers (2) of the tenter clips (1), wherein the two tracks (6.1, 6.2) are respectively arranged on two mutually oppositely facing sides of the guide rail (5) parallel to the rotation axis of the sprocket (4), and wherein the guide rail (5) comprises at least one curved section (5.2) for deflecting the chain, characterized in that, in the area of the curved section (5.2) of the guide rail (5), connecting elements (8, 9, 10) are present, by which the guide rail (5) is connected with the deflecting device (3), wherein several connecting elements (8, 9, 10) are embodied in such a manner so that at least a part of the curved section (5.2) of the guide rail (5) is radially slidable with respect to the sprocket (4).

2. The deflecting device (3) according to claim 1, in which several connecting elements (8, 9, 10) are embodied in such a manner so that at least a part of the guide rail (5) is slidable tangentially with respect to the sprocket (4).

3. The deflecting device (3) according to claim 2, in which a straight section (5.3) of the guide rail (5) adjoins on the curved section (5.2) of the guide rail (5), wherein the straight section (5.3) is slidably connected with the deflecting device (3) in the longitudinal direction of the guide rail (5).

4. The deflecting device (3) according to claim 1, with a rail carrier (9), which comprises a curved section (9.1), which extends parallel to the curved section (5.2) of the guide rail (5), wherein the guide rail (5) is connected with the deflecting device (3) via the rail carrier (9).

5. The deflecting device (3) according to claim 4, in which several connecting elements (8, 9, 10) are embodied as studs (8) with a longitudinal direction, wherein the studs (8) are mounted on the rail carrier (9) in such a manner so that their longitudinal direction extends radially to the sprocket (4).

6. The deflecting device (3) according to claim 5, in which the studs (8) are supported slidably in their longitudinal direction.

7. The deflecting device (3) according to claim 5, in which the guide rail (5) is connected with the studs (8) in such a manner so that it is slidable with respect to the studs (8).

8. The deflecting device (3) according to claim 7, in which furthermore several clamping elements (10) are provided as connecting elements (8, 9, 10) via which the guide rail (5) is connected with the studs (8).

9. The deflecting device (3) according to claim 8, in which the clamping elements (10) and the studs (8) are embodied in such a manner so that the clamping elements (10) are slidable with respect to the studs (8) in their longitudinal direction or transversely thereto.
